(19) United States
(12) Patent Application Publication
(10) Pub. No.: US 2025/0122114 A1
(43) Pub. Date: Apr. 17, 2025

(54) FABRICATION PHOSPHATE TELLURIDE GLASS FOR VARIETY PHOTONIC APPLICATIONS

(71) Applicants: El Sayed YOUSEF, Abha (SA); Mohammed S. ALQAHTAN, Abha (SA); A.M. ALSHEHRI, Abha (SA); Raouia LACHHEB, Abha (SA); Bozena BURTANGWIZDALA, Cracow (PL); Manuela REBEN, Cracow (PL); Christian RUSSEL, Jena (DE)

(72) Inventors: El Sayed YOUSEF, Abha (SA); Mohammed S. ALQAHTAN, Abha (SA); A.M. ALSHEHRI, Abha (SA); Raouia LACHHEB, Abha (SA); Bozena BURTANGWIZDALA, Cracow (PL); Manuela REBEN, Cracow (PL); Christian RUSSEL, Jena (DE)

(21) Appl. No.: 18/949,665

(22) Filed: Nov. 15, 2024

(30) Foreign Application Priority Data
Jan. 12, 2024 (IN) 202441002596

(51) Int. Cl. C03C 3/247

(52) U.S. Cl. CPC C03C 3/247

(57) ABSTRACT

The present invention relates to a glass composition glass follows: 40P₂O₅%-(25-29) ZnO %-15BaF₂%-15TeO₂%-5Ag₂O %-1.0La₂O₃% 15000 ppm R₂O₃ (R=Eu, Er, Pr, Nd) were fabricated by melting casting method with reducing OH. The glass containing 1% La2O3 without doped rare earth ions has highest thermal stability. Otherwise, the glass doped with and La, Pr ion has lowest thermal stability and highest optical band gap. Herein we determine the peak emission wavelength (λₚₑₐₖ, in nm), effective bandwidths (Δλ_{eff}, in nm), FWHM, the fluorescence lifetime (τₘₑₛ, ms), fluorescence lifetime (τₘₑₛ), Peak emission cross-section (×10⁻²⁵ cm²), Gain, optical gain (σₑ×τₘₑₛ×10⁻²⁵ cm²ms), and gain bandwidth (σₑ×Δλ_{eff}×10⁻²⁵ cm²). These results of the fabricated glass provide us of the invention; this glass can be suitable for use on a L-band amplification and high-power laser device.

### FIELD OF INVENTION

The present invention relates to a discipline of photonic devices, namely the modification of phosphate glass by the addition of fluorine ions and tellurite oxide. It may be used to a high-power laser device with a high emission cross section, high both optical band gap and thermal stability, and low photon OH band. Therefore, it can also be used to expand the L-band communication window and high power laser source depending on the pumping excitation wavelength.

### BACKGROUND OF THE INVENTION

The background description includes basic of the field of invention including a study of recent technologies along with a few patent literatures that may be useful in understanding the present invention. Data is an asset for businesses of all sizes. On an average, organizations experience 20% to 40% data growth per year.

In the creation of materials, glasses are both the newest and the oldest, and they are utilized for a multitude of purposes in ordinary life. When the arrangement of glass's molecule components is irregular on a scale larger than a few times the size of these groups, we say that the glass has no long-range order.

Glass and other amorphous materials are notoriously difficult for theorists to analyze due to a lack of definitive experimental data on their characteristics and structures.

In order to take advantage of future benefits, research must close this gap. This includes developing the fundamentals of new optical glasses as well as new applications like waveguide lasers, bulk lasers, up-converting glasses, optical switches, second-harmonic generation, and third-order nonlinear optical materials.

Classic glass network formers such as TeO₂ and P₂O₅ are well recognized. On the basis of this, other systems of tellurite and phosphate glass have been studied and created for many different kinds of uses. Phosphate laser glasses combined with aluminate or silicate laser glasses or even tellurite laser glasses have attracted a lot of attention in the scientific community. Both bulk lasers and optical fibers made from phosphate glasses serve as gain medium for lasers.

Doped rare earth phosphate tellurite glasses have been studied extensively recently. There is proof that phosphate gases are far more resistant to heat than tellurite glasses. To discover a happy medium between the qualities of pure tellurite and phosphate glass, tellurite-phosphate glasses have recently attracted a lot of research. Doping host glass systems with rare earth elements including neodymium, erbium, praseodymium, and europium gives the development of phosphate tellurite laser glasses. Stimulated emission from excited rare earth element ions within the glass is responsible for the lasing capabilities of rare earth doped laser glasses.

Several scientists have recently found evidence of energy transfer between Er³⁺ and other rare earth ions including Nd³⁺ and Pr³⁺. Phosphate tellurite glasses doped with erbium possess optical and chemical characteristics suitable for use in optical applications.

Thulium, praseodymium, neodymium, and dysprosium are among the other lanthanide ions that are extremely sought after, since they have the ability to extend a transmission's wavelength domain up to 1.3 μm, a higher energy level.

Due to its high emission at around 1.06 μm, neodymium (Nd³⁺) has been identified as one of the most effective rare earth ions for solid-state lasers in a range of hosts. Additionally, Nd³⁺ ion absorption provides advantages for solar cells and a strong candidate for increasing pumping efficiency.

Tellurite-phosphate glasses have several practical uses; however, the literature is limited on information on their optical characteristics and thermal stability. Therefore, this invention aims to investigate the thermal and optical characteristics of a phosphate-tellurite glass system doped with various rare earth elements.

### OBJECTS OF THE INVENTION

The principal object of the invention is for production of novel glass composition consists of two glass former tellurite and phosphate oxide with ZnO, BaF₂, Ag₂O, La₂O₃ doped rare earth ions Eu₂O₃, Er₂O₃, Pr₂O₃, Nd₂O₃. The advantage properties of this glass have high glass transition, suitable optical band gap to accept and solubility of doping with rare earth ion. Furthermore, these glass high thermal stability, anticrystallization, low durability with low OH band, high absorption and emission cross section.

### SUMMARY OF THE INVENTION

The object of the invention is achieved using a fabricated glass. The composition of the fabrication glass has phosphorus pentoxide by weight of composition 40 percentage, zinc oxide by weight of composition ranging from 25-29 percentage, barium fluoride by weight of composition 15 percentage, Tellurium dioxide by weight of composition 15 percentage and remaining are one or more additives selected from the group of Silver oxide, Lanthanum (III) oxide, Europium (III) oxide, Erbium (III) oxide, Praseodymium oxide, and Niobium pentoxide.

Another embodiment of the present invention is that the additive is selected as Silver oxide, such that the fabricated glass has 5 percentage of Silver oxide, wherein the fabricated glass is doped with the Silver oxide.

Another embodiment of the present invention is that the additive is selected as Silver oxide and Europium (III) oxide, such that the fabricated glass has 5 percentage of silver oxide and 15000 parts per million of Europium (III) oxide, wherein the glass is doped with the Silver oxide and Europium (III) oxide.

Another embodiment of the present invention is that the additive is selected as Silver oxide, Europium (III) oxide and Niobium pentoxide such that the fabricated glass has 5 percentage of silver oxide, 15000 parts per million of Europium (III) oxide and 15000 parts per million of Niobium pentoxide, wherein the glass is doped with the Silver oxide, Europium (III) oxide and Niobium pentoxide.

Another embodiment of the present invention is that the additive is selected as Silver oxide, Erbium (III) oxide and Niobium pentoxide such that the fabricated glass has 5 percentage of silver oxide, 15000 parts per million of Erbium (III) oxide and 15000 parts per million of Niobium pentoxide, wherein the glass is doped with the Silver oxide, Erbium (III) oxide and Niobium pentoxide.

Another embodiment of the present invention is that the additive is selected as Lanthanum (III) oxide, such that the fabricated glass has 1 percentage of Lanthanum (III) oxide, wherein the glass is doped with Lanthanum (III) oxide.

Another embodiment of the present invention is that the additive is selected as Lanthanum (III) oxide and Praseodymium oxide, such that the fabricated glass has 1 percentage of Lanthanum (III) oxide and 15000 parts per million of Praseodymium oxide, wherein the glass is doped with Lanthanum (III) oxide and Praseodymium oxide.

Another embodiment of the present invention is that the additive is selected as Lanthanum (III) oxide and Erbium (III) oxide, such that the fabricated glass has 1 percentage of Lanthanum (III) oxide and 15000 parts per million of Erbium (III) oxide, wherein the glass is doped with Lanthanum (III) oxide and Erbium (III) oxide.

Another embodiment of the present invention is that the additive is selected as Lanthanum (III) oxide and Niobium pentoxide, such that the fabricated glass has 1 percentage of Lanthanum (III) oxide and 15000 parts per million of Niobium pentoxide, wherein the glass is doped with Lanthanum (III) oxide and Niobium pentoxide.

Another embodiment of the present invention is that the additive is selected as Lanthanum (III) oxide, Erbium (III) oxide and Praseodymium oxide, such that the fabricated glass has 1 percentage of Lanthanum (III) oxide, 15000 parts per million of Erbium (III) oxide and 15000 parts per million of Praseodymium oxide, wherein the glass is doped with Lanthanum (III) oxide, Erbium (III) oxide and Praseodymium oxide.

### BRIEF DESCRIPTION OF DRAWINGS

It is to be noted, however, that the appended drawings illustrate only typical embodiments of the present subject matter and are therefore not to be considered for limiting of its scope, for the invention may admit to other equally effective embodiments. The detailed description is described with reference to the accompanying figures. In the figures, a reference number identifies the figure in the reference number first appears. The same numbers are used throughout the figures to reference like features and components. Some embodiments of system or method or structure in accordance with embodiments of the present subject matter are now described, by way of example, and with reference to the accompanying figures, in which:

FIG. 1. (a, b) DTA profile of all prepared glasses.

FIG. 2. Absorption spectrum of the prepared glass MS1 (undoped glass).

FIG. 3. Absorption spectrum of MS2 (Eu₂O₃ 15000 ppm).

FIG. 4. Absorption spectrum of MS3 (Nd₂O₃ 15000 ppm)_(Eu₂O₃ 15000 ppm).

FIG. 5. Absorption spectrum of MS4 (Nd₂O₃ 15000 ppm)_(Er₂O₃ 15000 ppm).

FIG. 6. Absorption spectrum of the prepared glass MS5 (undoped glass).

FIG. 7. Absorption spectrum of MS6 glass (Pr₂O₃ 15000 ppm).

FIG. 8. Absorption spectrum of MS7 (Er₂O₃ 15000 ppm).

FIG. 9. Absorption spectrum of MS8 (Nd₂O₃ 15000 ppm).

FIG. 10. Absorption spectrum of MS9 (Pr₂O₃ 15000 ppm)_(Er₂O₃ 15000 ppm).

FIG. 11. (αhv)^{1/2} as a function of hv of all prepared glasses.

FIG. 12. The fluorescence emission spectra for MS4 (Nd₂O₃ 15000 ppm/Er₂O₃ 15000 ppm) glass and MS7 (Er₂O₃ 15000 ppm) glass under an excitation wavelength of 380 nm.

FIG. 13. The fluorescence emission spectra for MS9 (Pr₂O₃ 15000 ppm/Er₂O₃ 15000 ppm) glass and MS6 (Pr₂O₃ 15000 ppm) glass under an excitation wavelength of 445 nm.

FIG. 14. The fluorescence emission spectra for MS9 (Pr₂O₃ 15000 ppm/Er₂O₃ 15000 ppm) glass and MS7 (Er₂O₃ 15000 ppm) glass under an excitation wavelength of 380 nm.

FIG. 15. The excitation spectra for MS9 (Pr₂O₃ 15000 ppm/Er₂O₃ 15000 ppm) glass and MS6 (Pr₂O₃ 15000 ppm) glass under an emission wavelength of 600 nm.

FIG. 16. The excitation spectra for MS9 (Pr₂O₃ 15000 ppm/Er₂O₃ 15000 ppm) glass and MS6 (Pr₂O₃ 15000 ppm) glass under an emission wavelength of 1032 nm.

FIG. 17. The excitation spectra for MS4 (Nd₂O₃ 15000 ppm/Er₂O₃ 15000 ppm) glass and MS7 (Er₂O₃ 15000 ppm) glass under an emission wavelength of 1532 nm.

FIG. 18. The excitation spectra for MS9 (Pr₂O₃ 15000 ppm/Er₂O₃ 15000 ppm) glass and MS7 (Er₂O₃ 15000 ppm) glass under an emission wavelength of 1532 nm.

FIG. 19. Fluorescence decay curve of MS4 (Nd₂O₃ 15000 ppm/Er₂O₃ 15000 ppm) glass: ⁴F_{3/2} state of Nd³⁺ ions.

FIG. 20. Fluorescence decay curve of MS4 (Nd₂O₃ 15000 ppm/Er₂O₃ 15000 ppm) glass: ⁴I_{13/2} state of Er³⁺ ions.

FIG. 21. Fluorescence decay curve of MS7 (Er₂O₃ 15000 ppm) glass: ⁴I_{13/2} state of Er³⁺ ions.

FIG. 22. Fluorescence decay curve of MS4 (Nd₂O₃ 15000 ppm/Er₂O₃ 15000 ppm) glass: ⁴S_{3/2} state of Er³⁺ ions.

FIG. 23. Fluorescence decay curve of MS9 (Pr₂O₃ 15000 ppm/Er₂O₃ 15000 ppm) glass and MS6 (Pr₂O₃ 15000 ppm) glass: ³P₀ state of Pr³⁺ ions.

FIG. 24. Fluorescence decay curve of MS9 (Pr₂O₃ 15000 ppm/Er₂O₃ 15000 ppm) glass and MS7 (Er₂O₃ 15000 ppm) glass: ⁴F_{9/2} state of Er³⁺ ions.

FIG. 25. Fluorescence decay curve of MS9 (Pr₂O₃ 15000 ppm/Er₂O₃ 15000 ppm) glass and MS7 (Er₂O₃ 15000 ppm) glass: ⁴S_{3/2} state of Er³⁺ ions.

FIG. 26. Absorption and emission cross section for MS4 glass of the transition ⁴I_{13/2}→⁴I_{15/2}.

FIG. 27. Gain coefficient for of the transition ⁴I_{13/2}→⁴I_{15/2} of MS4 glass.

FIG. 28. Absorption and emission cross section for MS7 glass of the transition ⁴I_{13/2}→⁴I_{15/2}.

FIG. 29. Gain coefficient for of the transition ⁴I_{13/2}→⁴I_{15/2} of MS7 glass.

The figures depict embodiments of the present subject matter for the purposes of illustration only. A person skilled in the art will easily recognize from the following description that alternative embodiments of the device and process illustrated herein may be employed without departing from the principles of the disclosure described herein.

### DETAILED DESCRIPTION

The best and other modes for carrying out the present invention are presented in terms of the embodiments, herein depicted in Drawings provided. The embodiments are described herein for illustrative purposes and are subject to many variations. It is understood that various omissions and substitutions of equivalents are contemplated as circumstances may suggest or render expedient, but are intended to cover the application or implementation without departing from the spirit or scope of the present invention. Further, it is to be understood that the phraseology and terminology employed herein are for the purpose of the description and should not be regarded as limiting. Any heading utilized within this description is for convenience only and has no legal or limiting effect.

The terms “a” and “an” herein do not denote a limitation of quantity, but rather denote the presence of at least one of the referenced items.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more sub-systems or elements or structures or components preceded by “comprises . . . a” does not, without more constraints, preclude the existence of other, sub-systems, elements, structures, components, additional sub-systems, additional elements, additional structures or additional components. Appearances of the phrase “in an embodiment”, “in another embodiment” and similar language throughout this specification may, but not necessarily do, all refer to the same embodiment.

For the purpose of promoting an understanding of the principles of the invention, reference will now be made to the embodiment illustrated in the figures and specific language will be used to describe them. It will nevertheless be understood that no limitation of the scope of the invention is thereby intended. Such alterations and further modifications in the illustrated system, and such further applications of the principles of the invention as would normally occur to those skilled in the art are to be construed as being within the scope of the present invention.

It will be understood by those skilled in the art that the foregoing general description and the following detailed description are exemplary and explanatory of the invention and are not intended to be restrictive thereof.

Unless otherwise defined, all technical and scientific terms used herein have the same meanings as commonly understood by those skilled in the art to which this invention belongs.

The system, method and examples provided herein are only illustrative and not intended to be limiting.

Embodiments of the present invention will be described below in detail with reference to the accompanying figures.

The glass composition created by this invention is as follows: 40P₂O₅%-(25-29) ZnO %-15BaF₂%-15TeO₂%-5Ag₂O %-1.0La₂O₃%15000 ppm R₂O₃ (R=Eu, Er, Pr, Nd). The raw materials are weighed and uniformly mixed, and then glass melt into platinum/silica/alumina/crucible and consequently casting is occurred, and after annealing and cooling to get form of produced glass.

Reducing the linear refractive index and dispersion of tellurite based glass by adding P₂O₅ as network former. At the same time, increasing the thermal stability, optical band gap and anticrystallization. Finally, the goal of significantly reducing OH by adding 15% BaF₂ is achieved.

According to the influence of the rare earth ions Eu, Er, Pr, Nd and codoped ions Eu/Nd, Er/Nd, Er/Pr on the stimulated emission cross section in order to improve the stimulated emission cross section of host glass, and at the same time ensure that the glass has better production and processing characteristics.

The one embodiment of the present invention where the fabricated glass comprising phosphorus pentoxide by weight of composition 40 percentage, zinc oxide by weight of composition ranging from 25-29 percentage, barium fluoride by weight of composition 15 percentage, Tellurium dioxide by weight of composition 15 percentage and remaining are one or more additives selected from the group of Silver oxide, Lanthanum (III) oxide, Europium (III) oxide, Erbium (III) oxide, Praseodymium oxide, and Niobium pentoxide.

Furthermore, we estimated the peak emission wavelength, effective bandwidths, FWHM of emission spectra, the fluorescence lifetime, Peak emission cross-section, optical gain, and gain bandwidth. These characteristics of the fabricated glass of this invention very suitable for use in a L-band amplification and high-power laser device.

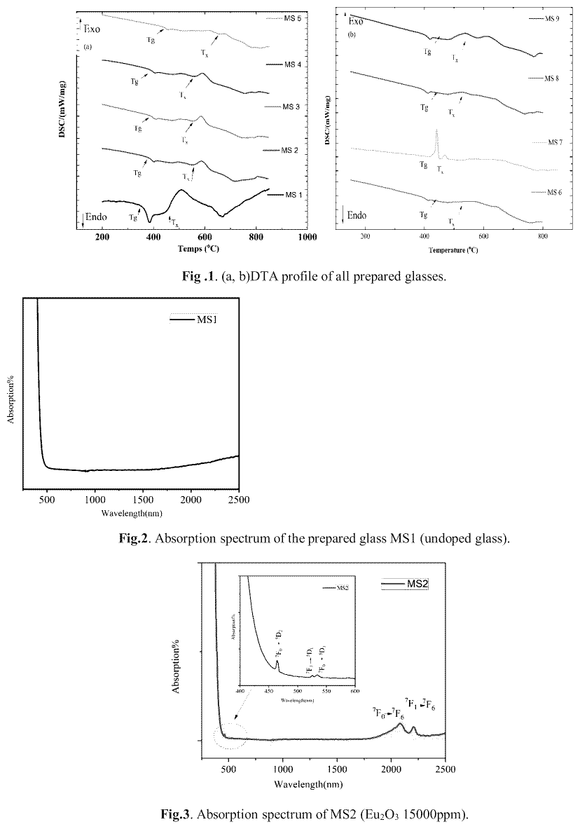

FIG. 1 shows the DTA patterns of all prepared glasses. The glass transition (T_{g} in ° C.), the onset crystallization temperature (Tx in ° C.), and the crystallization temperature (Tm in ° C.) are listed in the Table 2.

FIG. 2 shows the absorption spectrum of the undoped glass MS1. The absorption spectrum of the prepared glass MS2 is shown in the FIG. 3 at room temperature. The absorbance spectra of the produced glass, MS2 is shown in FIG. 3 at room temperature shows three absorption bands from the ground state ⁷F₀ at 2084 nm (⁷F₆), 534 nm (⁵D₁), and 464 nm (⁵D₂), whereas other two peaks originate from ⁷F₁ state to 2208 nm (⁷F₆) and 525 nm (⁵D₁). The absorbance spectra of the produced glass, MS3 is shown in FIG. 4. The absorption bands at 1599 nm, 873 nm, 803 nm, 746 nm, 681 nm, 628 nm, 580 nm 519 nm, 467 nm, and 427 nm are assigned to the transitions of the ions Nd³⁺ from ⁴I_{9/2} to ⁴I_{15/2}, ⁴F_{3/2}, ⁴F_{5/2}+²H_{9/2}, ⁴F_{7/2}, ⁴F_{9/2}, ²H_{11/2}, ⁴G_{5/2}+²G_{7/2}, ⁴G_{7/2}, ⁴G_{9/2}, and ⁴P_{1/2}+²D_{5/2}, whereas the other observed transitions of the ions Eu³⁺ from the ground state ⁷F₀ to ⁷F₆ (2082 nm), then from the state ⁷F₁ to ⁷F₆ (2208 nm).

FIG. 5 shows the absorption spectrum of the prepared glass MS4. The absorption bands at 877 nm, 803 nm, 746 nm, 681 nm, 650 nm, 580 nm, 519 nm, and 486 nm are assigned to the transitions of the ions Nd³⁺ from ⁴I_{9/2} to 4F_{3/2}, ⁴F_{5/2}+²H_{9/2}, ⁴F_{7/2}, ⁴F_{9/2}, ²H_{11/2}, ⁴G_{5/2}+²G_{7/2}, ⁴G_{7/2}, and 4G_{9/2}, whereas the other observed transitions of Er³⁺ from the ground state ⁴I_{15/2} to ⁴I_{15/2} (1527 nm), and ⁴I_{11/2} (977 nm).

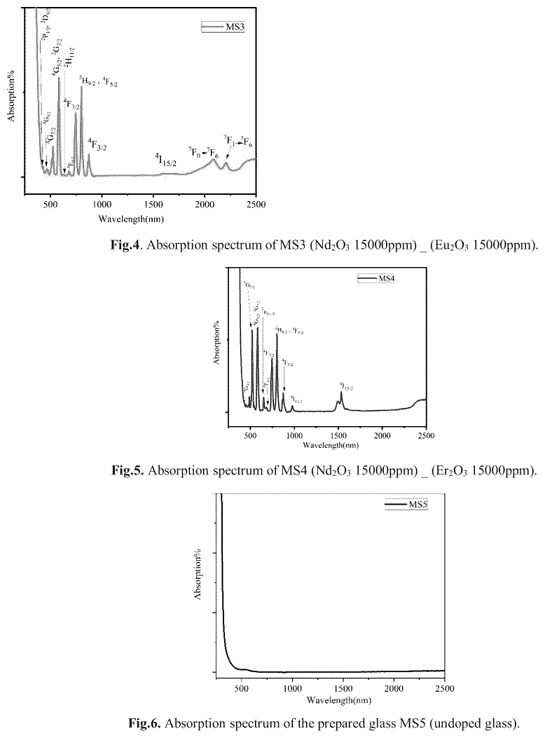

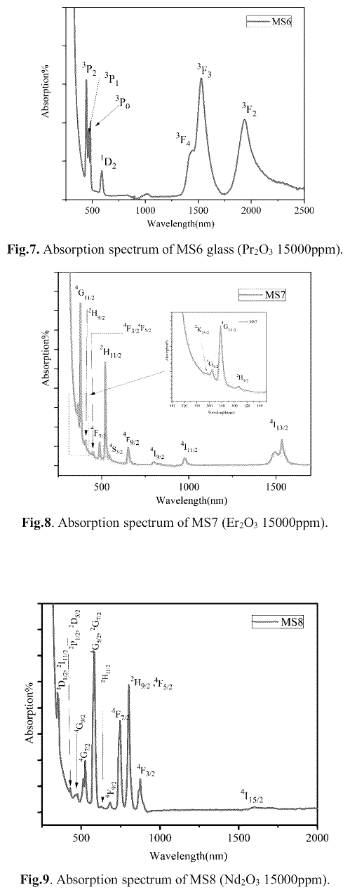

FIG. 6 displays the undoped glass MS5 absorption spectrum. FIG. 7 shows the absorption spectrum of the prepared glass MS6. The spectrum contains seven peaks assigned to the Pr³⁺ ions from the level ³H₄ to ³F₂, ³F₃, ³F₄, ¹D₂, ³P₀, ³P₁ and ³P₂ at 1934 nm, 1527 nm, 1436 nm, 589 nm, 480 nm, 462 nm, and 441 nm, respectively.

The optical absorbance spectrum in UV-VIS-NIR of the prepared glass doped with erbium oxide were shown in the FIG. 8. FIG. 8 exhibit thirteen peaks at the wavelengths around 1515 nm, 977 nm, 798 nm, 651 nm, 542 nm, 522 nm, 488 nm, 449 nm, 446 nm, 405 nm, 377 nm, 364 nm, and 356 nm that correspond to the transition from the ground state of ⁴I_{15/2} to the exited state of ⁴I_{13/2}, ⁴I_{11/2}, ⁴I_{9/2}, ⁴F_{9/2}, ⁴S_{3/2}, ²H_{11/2}, ⁴F_{7/2}, ⁴F_{5/2}, ⁴F_{3/2}, ²H_{9/2}, ⁴G_{11/2}, ⁴G_{9/2}, and ²K_{15/2} respectively.

FIG. 9 shows the absorption spectrum of the prepared glass MS8 doped with Nd₂O₃ range from 250 to 2000 nm. The absorption bands at 1585 nm, 874 nm, 802 nm, 741 nm, 684 nm, 629 nm, 581 nm 520 nm, 469 nm, 429 nm, and 351 nm are corresponding to the transitions from ⁴I_{9/2} to ⁴I_{15/2}, ⁴F_{3/2}, ⁴F_{5/2}+²H_{9/2}, ⁴F_{7/2}, ⁴F_{9/2}, ²H_{11/2}, ⁴G_{5/2}+²G_{7/2}, ⁴G_{7/2}, ⁴G_{9/2}, ⁴D_{1/2}+²I_{11/2}, ⁴P_{1/2}+²D_{5/2}.

FIG. 10 shows the absorption spectrum of the prepared glass MS9. The spectrum contains peaks of the Pr³⁺ ions from the level ³H₄ to ³F₂, ³F₃, ³F₄, ¹D₂, ³P₀, ³P₁ and ³P₂ at 1934 nm, 1527 nm, 1436 nm, 589 nm, 480 nm, 462 nm, and 441 nm, respectively. Whereas the spectrum exhibit peaks related to the Er³⁺ ions at the wavelengths around 977 nm, 798 nm, 651 nm, 542 nm, 522 nm, 405 nm, 377 nm, 364 nm, and 356 nm that correspond to the transition from the ground state of ⁴I_{15/2} to the exited state of ⁴I_{11/2}, ⁴I_{9/2}, ⁴F_{9/2}, ⁴S_{3/2}, ²H_{11/2}, ²H_{9/2}, ⁴G_{11/2} and ⁴G_{9/2}, respectively.

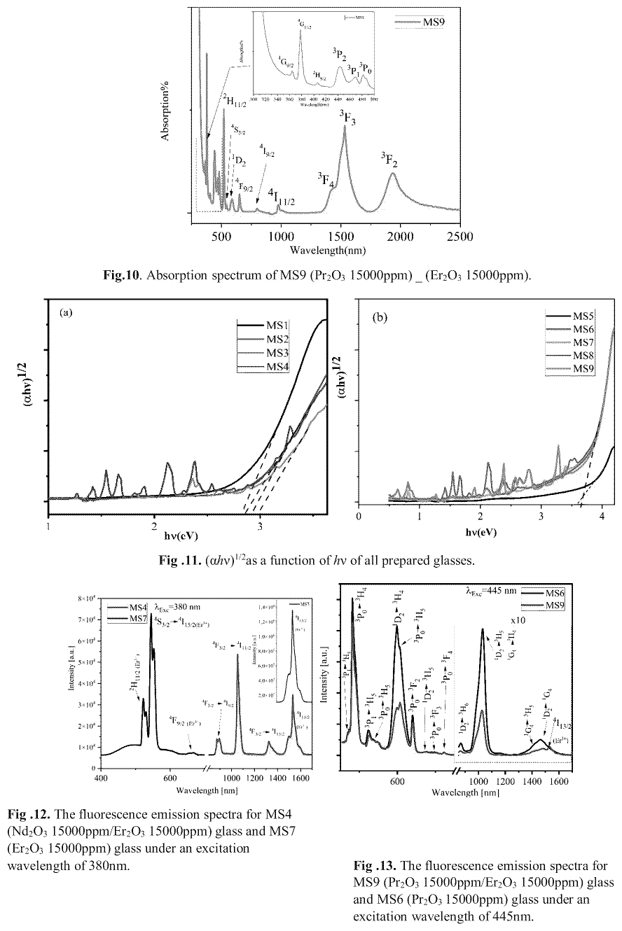

FIG. 11 shows the measured energies gaps for all prepared glasses. The measured energy gap for each glass are listed in the Table 2. The fluorescence emission spectra of Er³⁺ ions doped MS4 and MS7 glasses under excitation at 380 nm is shown in FIG. 12. The emission spectra UV-NIR appeared seven emissions. Four peaks emission peak bands centered at 1534 nm, 666 nm, 545 nm and 525 nm attributed to ⁴I_{15/2}→⁴I_{13/2}, ⁴F_{9/2}→⁴I_{13/2}, ⁴S_{3/2}→⁴I_{13/2}, and ²H_{11/2}→⁴I_{13/2 transitions of Er}³⁺ ions, respectively. Meanwhile, the NIR emission peaks cantered at 1324m, 1054 nm and 885 nm attributed to ⁴F_{3/2}→⁴I_{13/2}, ⁴F_{3/2}→⁴I_{11/2}, and ⁴F_{3/2}→⁴F_{9/2} transitions of Nd³⁺ ions, respectively.

FIG. 13 shows the emission spectra of MS6 and MS9 samples. The UV-NIR emission spectra under excitation 445 nm represent fifteen emission peaks. For Pr³⁺ singly-doped glass MS6, the emission bands centred at 1460 nm (¹D₂→¹G₄), 1405 nm (¹G₄→³H₅), 1031 nm (¹D₂→³H₅, ¹G₄→³H₄), 722 nm (¹D₂→³H₆), 699 nm (³P₀→³F₄), 673 nm (³P₀→³F₃), 639 nm (¹D₂→³H₅), 606 nm (³P₀→³F₂), 598 nm (¹D₂→³H₄), 538 nm (³P₀→³H₅), 523 nm (³P₁→³H₅), 481 nm (³P₀→³H₄), and 470 nm (³P₁→³H₄), respectively. For Er³⁺/Pr³⁺ co-doped MS9 glass, the same emission bands appeared with the addition of the band at 1532 nm, which is attributed for the transition ⁴I_{13/2}→⁴I_{15/2} of Er³⁺ ions.

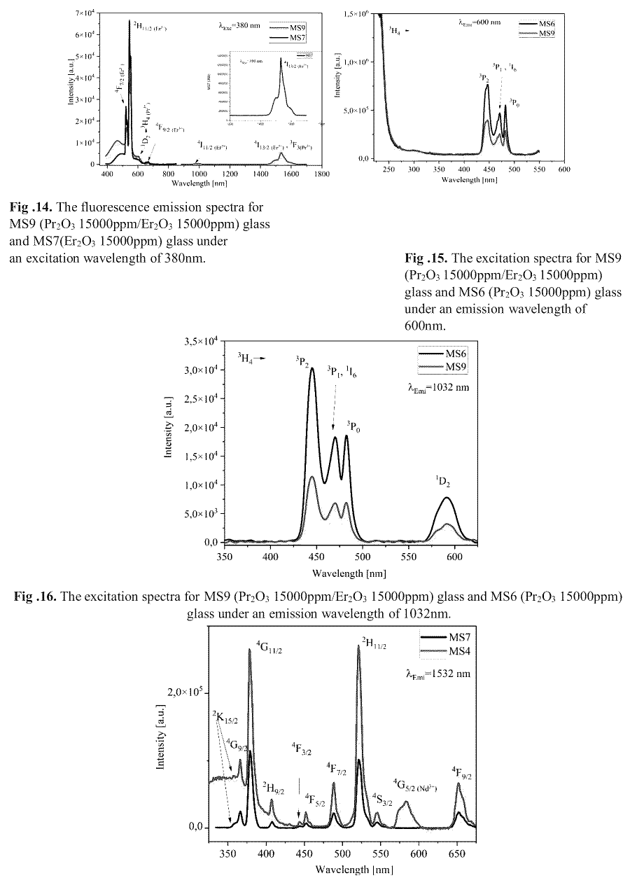

The emission spectra of MS7 and MS9 glasses under excitation of 380 nm showed six peaks at 1536 nm (⁴I_{13/2}→⁴I_{15/2}), 970 nm (⁴I_{11/2}→⁴I_{13/2}), 668 nm (⁴F_{9/2}→⁴I_{15/2}), 544 nm (²H_{11/2}→⁴I_{15/2}), 525 nm (⁴F_{7/2}→⁴I_{15/2}) for Er³⁺ ions and at 604 nm (¹D₂→³H₄) for Pr³⁺ ions (see FIG. 14).

The excitation spectra of MS6 and MS9 glasses under emission at 600 nm showed three peaks at 482 nm (³H₄→³P₀), 471 nm (³H₄→³P₁, ¹I₆), 446 nm (³H₄→³P₂), assigned for Pr³⁺ ions (see FIG. 15). The excitation spectra of MS6 and MS9 glasses under emission at 1032 nm appeared four peaks at 591 nm (³H₄→¹D₂), 482 nm (³H₄→³P₀), 471 nm (³H₄→³P₁, ¹I₆), 446 nm (³H₄→³P₂), assigned for Pr³⁺ ions (see FIG. 16).

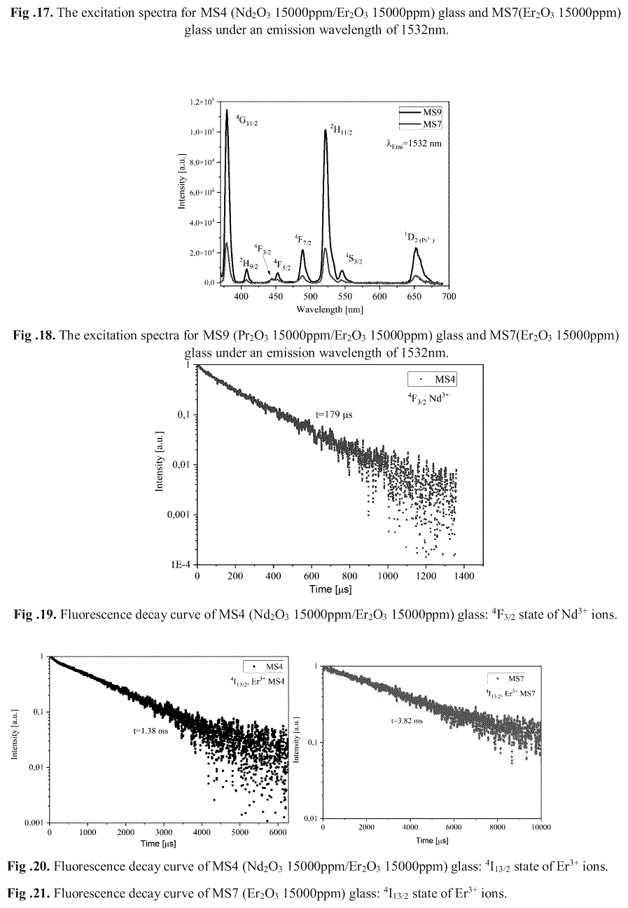

The excitation spectra of MS4 and MS7 glasses under emission at 1532 nm is showed in FIG. 17. The excitation spectrum of MS7 glass appeared ten emission bands assigned for Er³⁺ ions at 652 nm (⁴F_{9/2}→⁴I_{15/2}), 545 nm (⁴S_{3/2}→⁴I_{15/2}), 522 nm (²H_{11/2}→⁴I_{15/2}), 488 nm (⁴F_{7/2}→⁴I_{15/2}), 452 nm (⁴F_{5/2}→⁴I_{15/2}), 443 nm (⁴F_{3/2}→⁴I_{15/2}), 407 nm (²H_{9/2}→⁴I_{15/2}), 378 nm (⁴G_{11/2}→⁴I_{15/2}), 366 nm (⁴G_{9/2}→⁴I_{15/2}), and 357 nm (²K_{15/2}→⁴I_{15/2}). The glass MS4 showed the same emission bands with addition of the emission band of Nd³⁺ ions at 583 nm (⁴G_{5/2}→⁴I_{9/2}).

The excitation spectra of MS9 and MS7 glasses under emission at 1532 nm is showed in FIG. 18. The excitation spectra of MS9 and MS7 glasses appeared seven emission bands assigned for Er³⁺ ions at 545 nm (⁴S_{3/2}→⁴I_{15/2}), 522 nm (²H_{11/2}→⁴I_{15/2}), 488 nm (⁴F_{7/2}→⁴I_{15/2}), 452 nm (⁴F_{5/2}→⁴I_{15/2}), 443 nm (⁴F_{3/2}→⁴I_{15/2}), 407 nm (²H_{9/2}→⁴I_{15/2}), and 378 nm (⁴G_{11/2}→⁴I_{15/2}) and one emission band assigned to Pr³⁺ at 652 nm (⁴F_{9/2}→⁴I_{15/2}).

The evaluated fluorescence lifetime t, experimentally of the level ⁴F_{3/2} of the Nd³⁺ ions of MS4 codoped glass (Nd/Er) is shown in FIG. 19 and is equal to 179 μs. The estimated fluorescence lifetime t, experimentally of the level ⁴I_{13/2} of the Er³⁺ ions of MS4 co-doped glass (Nd/Er) is equal to 1.38 ms (see FIG. 20).

The calculated fluorescence lifetime τ, experimentally of the level ⁴I_{13/2} of the Er³⁺ ions of MS7 glass is shown in FIG. 21 and is equal to 3.82 ms.

The FIG. 22 present the evaluated fluorescence lifetime τ, experimentally of the level ⁴S_{3/2} of the Er³⁺ ions of MS4 glass and is equal to 0.77 μs. The FIG. 23 shows the estimated fluorescence lifetime τ, experimentally of the level ³P₀ of the Pr³⁺ ions for MS9 glass, and is equal to 0.39 us which is higher than MS6 glass (0.38 μs).

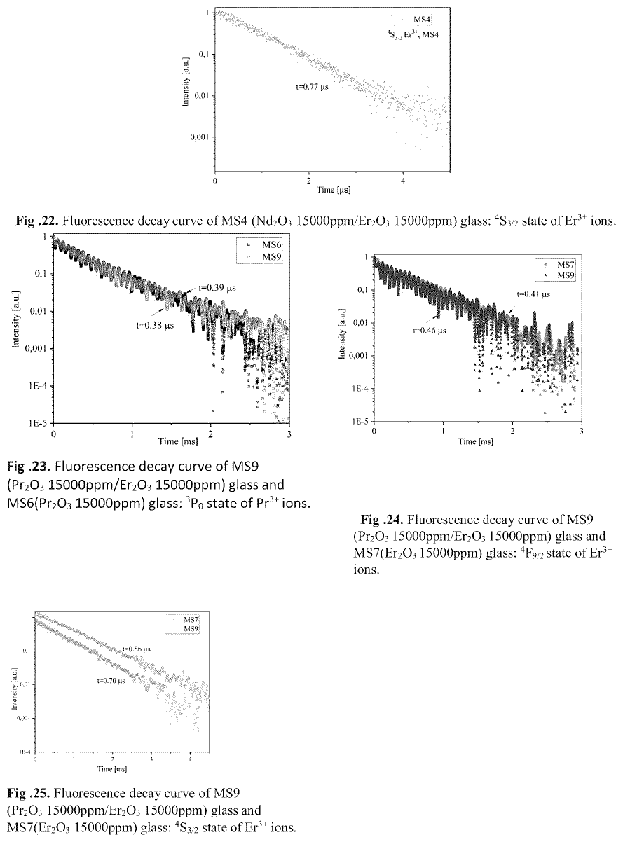

The FIG. 24 shows experimentally fluorescence lifetime τ of the level ⁴F_{9/2} of the Er³⁺ ions for MS9 glass and is equal to 0.46 us which is higher than MS7 glass (0.41 μs). The FIG. 25 shows experimentally fluorescence lifetime τ of the level ⁴S_{3/2} of the Er³⁺ ions for MS7 glass, and is equal to 0.86 μs which is higher than MS9 glass (0.70 μs).

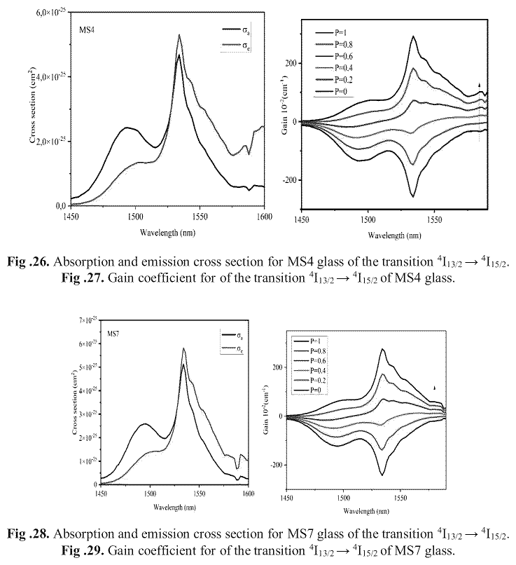

The emission cross section recorded a value equal to 5.25 10⁻²⁵ cm² (see FIG. 26). FIG. 27 shows the gain cross-section as a function of the wavelength under different population inversions. In the case of total inversion (P=1) at 1534 nm, we obtain a gain coefficient of 2.29 cm⁻¹ for MS4 glass. All the parameters related to the emission cross section are listed in Table 3.

The emission cross section recorded a value equal to 5.77 10⁻²⁵ cm² (see FIG. 28). FIG. 29 shows the gain cross-section as a function of the wavelength under different population inversions. In the case of total inversion (P=1) at 1534 nm, we obtain a gain coefficient of 2.76 cm⁻¹ for MS7 glass. All the parameters related to the emission cross section are listed in Table 3.

From the FIG. 1, the glass MS8 doped with Nd₂O₃ from the series of the glasses without addition of the silver oxide, shows a transition temperature less than the glass MS9 and MS6. Otherwise, glasses with addition of silver oxide show a low transition temperature than the other prepared glasses MS5, MS6, MS7, MS8 and MS9.

All phosphate glasses contain 15 mol % of the telluride oxide. This combination of two types of glasses affects the width of the band gap. The presence of the silver oxide Ag₂O in the glasses MS1, Ms2, MS3, and MS4 decrease the optical gaps between 2.823 eV to 2.983 eV. While, the glasses compositions MS5, MS6, MS7, MS8 and MS9 (without Ag₂O) recorded interesting optical gaps between 3.641 eV to 3.706 eV.

The emission spectrum of the glass MS7 doped with Er₂O₃ oxide shows an interesting emission intensity under an excitation wavelength of 380 nm (FIG. 12). MS4 glass was co-doped with Er₂O₃ and Nd₂O₃ oxides which decrease the emission intensity with the energy transfer from the Er³⁺ ions to Nd³⁺

The emission spectrum of the glass MS6 doped with Pr₂O₃ oxide shows an interesting emission intensity under an excitation wavelength of 445 nm (FIG. 13). MS9 glass was co-doped with Pr₂O₃ and Er₂O₃ oxides. The presence of the ⁴I_{13/2}→⁴I_{15/2} (Er³⁺) transition of Er³⁺ ions in the emission spectrum of MS9 confirms the energy transfer process from the Pr³⁺ to Er³⁺ ions. The near-infrared emission band at 1532 nm due to ⁴I_{13/2}→⁴I_{5/2} (Er³⁺) transition is overlapped with ¹G₄→³H₅ and ¹D₂→¹G₄ transitions of Pr³⁺ in MS9 glass samples co-doped with Pr³⁺/Er³⁺.

The emission spectrum of the glass MS7 doped with Er₂O₃ oxide shows an interesting emission intensity under an excitation wavelength of 380 nm (FIG. 14). MS9 glass was co-doped with Pr₂O₃ and Er₂O₃ oxides. The intensity of emission band at 1535 nm due to the main ⁴I_{13/2}→⁴I_{15/2} (Er³⁺) near-infrared laser transition is reduced, whereas the emission intensity of ¹D₂→³H₄ transition increase which clearly suggest the presence of energy transfer process from the Er³⁺ to Pr³⁺ ions.

The excitation intensity of the MS9 glasses under an emission wavelength 600 nm decrease comparing to the MS6 glass (FIG. 15) which can be explained with the presence of energy transfer process from the Pr³⁺ to Er³⁺ ions.

The excitation intensity of the MS9 glasses under an emission wavelength 1032 nm decrease comparing to the MS6 glass (FIG. 16) which can be explained with the presence of energy transfer process from the Pr³⁺ to Er³⁺ ions.

The excitation intensity of the MS4 glasses under an emission wavelength 1532 nm increase comparing to the MS7 glass (FIG. 17). The excitation intensity of the MS9 glasses under an emission wavelength 1532 nm increase comparing to the MS7 glass (FIG. 18).

From the FIG. 23, the fluorescence lifetime for the ³P₀ level of the Pr³⁺ ions of the MS9 glass increase slightly comparing to MS6 glass. From the FIG. 24, the fluorescence lifetime for the 4F_{9/2} state of Er³⁺ ions of MS9 glass increase comparing to MS7 glass. From the FIG. 25, the fluorescence lifetime for the 4S_{3/2} state of Er³⁺ ions of MS9 glass decrease comparing to MS7 glass which is can be explained with the energy transfer process from the Er³⁺ to Pr³⁺ ions.

The glass MS4 exhibit a large effective bandwidth (Δλ_{eff}) comparing to MS7 glass. MS4 glass recorded an interesting optical gain (σₑ×τₘₑₛ) and gain bandwidth (σₑ×Δλ_{eff}) at 1534 nm laser transition for the Erbium ions. These results prove that the presence of the Nd₂O₃ optimize the laser performance.

Table 1 illustrates the composition of the prepared glasses. Table 2 illustrates the density, the refractive index (moss model), gap energy, the transition temperature, the crystallization temperature and the onset crystallization temperature for all the prepared glasses. Table 3 illustrates the measured fluorescence lifetime (τₘₑₛ) for MS4, MS6, MS7, and MS9 samples. Table 4 illustrates the peak emission wavelength (λₚₑₐₖ, nm), effective bandwidths (Δλ_{eff}, nm), FWHM, The fluorescence lifetime (τₘₑₛ, ms), Peak emission cross-section (×10⁻²⁵ cm²), Gain, optical gain (σₑ×τₘₑₛ×10⁻²⁵ cm² ms), and gain bandwidth (σₑ×Δλ_{eff}×10⁻²⁵ cm²).

TABLE 1
The composition of the prepared glasses.

| | | | | | | | Eu₂O₃ | Er₂O₃ | Pr₂O₃ | Nd₂O₃ |
|---|---|---|---|---|---|---|---|---|---|---|
| | P₂O₅ | ZnO | BaF₂ | TeO₂ | Ag₂O | La₂O₃ | ppm | ppm | ppm | ppm |
| MS1 | 40 | 25 | 15 | 15 | 5 | — | — | — | — | — |
| MS2 | 40 | 25 | 15 | 15 | 5 | — | 15000 | — | — | — |
| MS3 | 40 | 25 | 15 | 15 | 5 | — | 15000 | — | — | 15000 |
| MS4 | 40 | 25 | 15 | 15 | 5 | — | — | 15000 | — | 15000 |
| MS5 | 40 | 29 | 15 | 15 | — | 1 | — | — | — | — |
| MS6 | 40 | 29 | 15 | 15 | — | 1 | — | — | 15000 | — |
| MS7 | 40 | 29 | 15 | 15 | — | 1 | — | 15000 | — | — |
| MS8 | 40 | 29 | 15 | 15 | — | 1 | — | — | — | 15000 |
| MS9 | 40 | 29 | 15 | 15 | — | 1 | — | 15000 | 15000 | — |

TABLE 2
The density, the refractive index (moss model), gap energy, the
transition temperature, the crystallization temperature and the
onset crystallization temperature for all the prepared glasses.

| | | | | | Density | Refractive |
|---|---|---|---|---|---|---|
| Composition | Eg(eV) | T_{g}(° C.) | Tₓ(° C.) | Tₘ(° C.) | (g/cm³) | index n moss |
| MS1 | 2.831 | 366 | 446 | 508 | 4.036212 | 2.406 |
| MS2 | 2.903 | 384 | 552 | 587 | 3.992812 | 2.391 |
| MS3 | 2.983 | 392 | 558 | 585 | 3.859718 | 2.375 |
| MS4 | 2.823 | 390 | 562 | 590 | 4.446540 | 2.408 |
| MS5 | 3.641 | 438 | 659 | 677 | 3.419376 | 2.260 |
| MS6 | 3.706 | 450 | 519 | 690 | 3.644601 | 2.250 |
| MS7 | 3.684 | 421 | 452 | 688 | 3.620933 | 2.253 |
| MS8 | 3.696 | 448 | 527 | 570 | 3.598174 | 2.251 |
| MS9 | 3.699 | 455 | 539 | 585 | 3.541243 | 2.251 |

TABLE 3
The measured fluorescence lifetime (τₘₑₛ) for MS4, MS6, MS7, and MS9 samples.

| | Compositions | | | |
|---|---|---|---|---|
| transition | MS4 | MS6 | MS7 | MS9 |
| The | ⁴F_{3/2}(Nd³⁺) 179 μs | ³P₀(Pr³⁺) 0.39 μs | ⁴F_{9/2}(Er³⁺)0.41 μs | ³P₀ (Pr³⁺) 0.38 μs |
| fluorescence | ⁴F_{9/2}(Er³⁺) 0.72 μs | | ⁴I_{13/2}(Er³⁺) 3.82 ms | ⁴F_{9/2}(Er₃₊) 0.46 μs |
| lifetime τₘₑₛ | ⁴I_{13/2}(Er³⁺)1.38 ms | | ⁴S_{3/2} (Er³⁺) 0.86 μs | ⁴S_{3/2} (Er³⁺) 0.7 μs |
| (ms) | ⁴S_{3/2} (Er³⁺) 0.77 μs | | | |

TABLE 4
The peakemission wavelength (λₚₑₐₖ, nm), effective bandwidths (Δλ_{eff}, nm),
FWHM, The fluorescence lifetime (τₘₑₛ, ms), Peak emission cross-section (×10⁻²⁵ cm²), Gain, optical gain
(σₑ × τₘₑₛ) 10⁻²⁵ cm²ms, and gain bandwidth (σₑ × Δλ_{eff}) × 10⁻²⁵ cm².

| | | | | | Peak | | | |
|---|---|---|---|---|---|---|---|---|
| | | | | The | emission | | | |
| | Peak emission | Effective | FWHM | fluorescence | cross- | | | |
| | wavelength | bandwidths | emission | lifetime τₘₑₛ | section | Gain | σₑ × τₘₑₛ | σₑ × Δλ_{eff} |
| Compositions | λₚₑₐₖ | (Δλ_{eff}) | bandwidth | (ms) | (10⁻²⁵) cm² | (cm⁻¹) | (10⁻²⁵ cm²ms) | (10⁻²⁵ cm²) |
| MS4 | 1534 | 40.27 | 31.284 | 1.38 | 5.25 | 2.92 | 6.562 | 211.41 |
| MS7 | 1534 | 36.22 | 30.50 | 3.82 | 5.77 | 2.76 | 22.041 | 208.989 |

We claim:

1. A fabricated glass comprising:
phosphorus pentoxide by weight of composition 40 percentage;
zinc oxide by weight of composition ranging from 25-29 percentage;
barium fluoride by weight of composition 15 percentage;
Tellurium dioxide by weight of composition 15 percentage; and
remaining are one or more additives selected from the group of Silver oxide, Lanthanum (III) oxide, Europium (III) oxide, Erbium (III) oxide, Praseodymium oxide, and Niobium pentoxide.

2. The glass as claimed in claim 1, wherein the additive is selected as Silver oxide, such that the fabricated glass has 5 percentage of Silver oxide, wherein the fabricated glass is doped with the Silver oxide.

3. The glass as claimed in claim 1, wherein the additive is selected as Silver oxide and Europium (III) oxide, such that the fabricated glass has 5 percentage of silver oxide and 15000 parts per million of Europium (III) oxide, wherein the glass is doped with the Silver oxide and Europium (III) oxide.

4. The glass as claimed in claim 1, wherein the additive is selected as Silver oxide, Europium (III) oxide and Niobium pentoxide such that the fabricated glass has 5 percentage of silver oxide, 15000 parts per million of Europium (III) oxide and 15000 parts per million of Niobium pentoxide, wherein the glass is doped with the Silver oxide, Europium (III) oxide and Niobium pentoxide.

5. The glass as claimed in claim 1, wherein the additive is selected as Silver oxide, Erbium (III) oxide and Niobium pentoxide such that the fabricated glass has 5 percentage of silver oxide, 15000 parts per million of Erbium (III) oxide and 15000 parts per million of Niobium pentoxide, wherein the glass is doped with the Silver oxide, Erbium (III) oxide and Niobium pentoxide.

6. The glass as claimed in claim 1, wherein the additive is selected as Lanthanum (III) oxide, such that the fabricated glass has 1 percentage of Lanthanum (III) oxide, wherein the glass is doped with Lanthanum (III) oxide.

7. The glass as claimed in claim 1, wherein the additive is selected as Lanthanum (III) oxide and Praseodymium oxide, such that the fabricated glass has 1 percentage of Lanthanum (III) oxide and 15000 parts per million of Praseodymium oxide, wherein the glass is doped with Lanthanum (III) oxide and Praseodymium oxide.

8. The glass as claimed in claim 1, wherein the additive is selected as Lanthanum (III) oxide and Erbium (III) oxide, such that the fabricated glass has 1 percentage of Lanthanum (III) oxide and 15000 parts per million of Erbium (III) oxide, wherein the glass is doped with Lanthanum (III) oxide and Erbium (III) oxide.

9. The glass as claimed in claim 1, wherein the additive is selected as Lanthanum (III) oxide and Niobium pentoxide, such that the fabricated glass has 1 percentage of Lanthanum (III) oxide and 15000 parts per million of Niobium pentoxide, wherein the glass is doped with Lanthanum (III) oxide and Niobium pentoxide.

10. The glass as claimed in claim 1, wherein the additive is selected as Lanthanum (III) oxide, Erbium (III) oxide and Praseodymium oxide, such that the fabricated glass has 1 percentage of Lanthanum (III) oxide, 15000 parts per million of Erbium (III) oxide and 15000 parts per million of Praseodymium oxide, wherein the glass is doped with Lanthanum (III) oxide, Erbium (III) oxide and Praseodymium oxide.
